(19) United States
(12) Patent Application Publication
(10) Pub. No.: US 2023/0297426 A1
(43) Pub. Date: Sep. 21, 2023

(54) RECONFIGURING REGISTER AND SHARED MEMORY USAGE IN THREAD ARRAYS

(71) Applicant: NVIDIA CORPORATION, Santa Clara, CA (US)

(72) Inventors: Rajballav DASH, San Jose, CA (US); Stephen JONES, San Francisco, CA (US); Jack Hilaire CHOQUETTE, Palo Alto, CA (US); Manan PATEL, San Jose, CA (US); Ronny M. KRASHINSKY, Portola Valley, CA (US); Shirish GADRE, Fremont, CA (US); Lixia QIN, Shanghai (CN)

(21) Appl. No.: 17/698,664

(22) Filed: Mar. 18, 2022

(51) Int. Cl. G06F 9/50; G06F 9/30

(52) U.S. Cl. CPC G06F 9/5022; G06F 9/30098; G06F 9/3005; G06F 2209/5011

(57) ABSTRACT

Various embodiments include techniques for utilizing resources on a processing unit. Thread groups executing on a processor begin execution with specified resources, such as a number of registers and an amount of shared memory. During execution, one or more thread groups may determine that the thread groups have excess resources needed to execute the current functions. Such thread groups can deallocate the excess resources to a free pool. Similarly, during execution, one or more thread groups may determine that the thread groups have fewer resources needed to execute the current functions. Such thread groups can allocate the needed resources from the free pool. Further, producer thread groups that generate data for consumer thread groups can deallocate excess resources prior to completion. The consumer thread groups can allocate the excess resources and initiate execution while the producer thread groups complete execution, thereby decreasing latency between producer and consumer thread groups.

### BACKGROUND

### Field of the Various Embodiments

Various embodiments relate generally to parallel processing compute architectures and, more specifically, to reconfiguring register and shared memory usage in thread arrays.

### Description of the Related Art

A computing system generally includes, among other things, one or more processing units, such as central processing units (CPUs) and/or graphics processing units (CPUs), and one or more memory systems. The GPU is capable of executing a large number (e.g., hundreds or thousands) of threads concurrently, where each thread is an instance of a program. Correspondingly, the GPU includes multiple processors, where each processor is configured to process one or more thread groups. As used herein, a thread group or warp refers to a group of threads concurrently executing the same program on different input data, with each thread of the group being assigned to a different execution unit within a processor. A plurality of related thread groups may be active (in different phases of execution) at the same time within a processor. This collection of thread groups is referred to herein as a cooperative thread array (CTA) or thread array. Warps and/or CTAs may further be grouped into cooperative group arrays (CGAs), and multiple CGAs may be grouped to execute an entire application program. Such a group of multiple CGAs is referred to herein as a grid or a kernel.

Each thread executing on a processor of the GPU acquires resources to execute certain functions, referred to herein as work, where the resources include registers, shared memory, and/or the like. The thread uses registers to store various values during mathematical calculations, to load data from and store data to memory, and/or the like. The thread uses shared memory to load data from and store data to memory, to transfer data to and from other threads executing within a warp, CTA, CGA, and/or grid, and/or the like. Warps executing in a CTA or CGA can be subject to a homogeneity restriction. With this homogeneity restriction, at the time a CTA or CGA is launched, each warp acquires the same amount of registers and shared memory used for executing the functions specified by the threads included in the warp. Warps executing in a CTA or CGA can further be subject to a permanence restriction. With this permanence restriction. The warps maintain the same amount of registers and shared memory, referred to herein as the footprint of the warp, until the CTA completes execution. These restrictions can lead to several disadvantages.

A first disadvantage of the above restrictions is that, in complex CTAs and CGAs, different concurrently executing warps may be performing different functions that have different resource requirements. Some warps may execute various mathematical functions, such as matrix multiplication, Fourier transforms, and/or the like. Such warps executing mathematical functions typically utilize a relatively large amount of registers and/or shared memory to store the data needed to perform the mathematical functions but need relatively few threads. Other warps may execute various data transfer functions to retrieve input data from long term memory, such as global memory. These warps executing data transfer functions may store the data in the shared memory for use by the warps executing the mathematical functions and typically copy data from global memory into staging buffers in shared memory. Warps executing data transfer functions utilize a relatively small amount of registers and/or shared memory to perform the data transfer functions but need a relatively large number of threads. Placing warps executing mathematical functions and warps executing data transfer functions within the same CTA or CGA allows the warps to take advantage of fast data synchronization mechanisms that threads within a CTA or CGA provide. However, because each warp acquires the same number of registers and same amount of shared memory, the warps executing data transfer functions acquire the same large amount of registers and/or shared memory as the warps executing mathematical functions, but do not utilize all of the acquired resources.

A second disadvantage of the above restrictions is that the resource requirements of warps in a CTA or CGA may change over time. For example, a warp may execute three consecutive functions, where the first function utilizes a large amount of resources and a small number of threads, a second function utilizes a small amount of resources and a large number of threads, and a third function utilizes a moderate amount of resources and a moderate number of threads. The warp acquires the resources needed to execute the first function, which requires the largest amount of resources. Further, the warp is sized to accommodate the largest number of threads utilized by the second function. However, the resources are underutilized when the warp executes the second function and the third function. Further, the threads are underutilized when the warp executes the first function and the third function.

A third disadvantage of the above restrictions is that the resource requirements of warps in a CTA or CGA may depend on the execution path of the warps. For example, a warp may test for a condition and, based on the condition, the warp may execute one of three execution paths, where each of the three execution paths executes a different function. The first execution path executes a first function that utilizes a large amount of resources. The second execution path executes a second function that utilizes a small amount of resources. The third execution path executes a third function utilizes a moderate amount of resources. The warp acquires the resources needed to execute the first function, which requires the largest amount of resources. However, if the warp executes the second execution path or the third execution path, the acquired resources are underutilized when the warp executes the second function or the third function.

One solution to at least the first disadvantage set forth above is to separate different functions with different resource requirements into different CTAs. For example, a first warp within a first CTA could execute a first function that utilizes a large amount of resources. The warp could store the results of the first function in memory and then complete. A second warp within a second CTA could retrieve the results of the first function and execute a second function that utilizes a small amount of resources. The warp could store the results of the second function in memory and then complete. A third warp within a third CTA could retrieve the results of the first function and/or second function and execute a third function that utilizes a moderate amount of resources. The warp could store the results of the third function in memory and then complete. Although this approach utilizes resources more efficiently, the amount of overhead time to launch each CTA, store the results, and complete the CTA involves a process that takes time to execute. This overhead time may be significant relative to the time to execute the actual functions, resulting in increased latency to execute the functions, thereby leading to reduced performance. Further, in legacy architectures, in order for these three CTAs to use different resources, these three CTAs would need to be in different kernels. As a result, launching the three kernels results in additional latency, which is in addition to the latencies for launching CTAs within a kernel. In addition, executing three separate kernels results in latency related storing and loading data from global memory.

As the foregoing illustrates, what is needed in the art are more effective techniques for executing functions on a processing unit with multiple threads of execution.

### SUMMARY

Various embodiments of the present disclosure set forth a computer-implemented method for launching compute tasks on a processing unit. The method includes executing a first group of threads, wherein a resource is allocated to the first group of threads being executed. The method further includes receiving a request to modify an allocation of the resource from the first group of threads while the first group of threads is executing. The method further includes modifying the allocation of the resource based on the request. When executing the method, the first group of threads continues execution after modifying the allocation.

Other embodiments include, without limitation, a system that implements one or more aspects of the disclosed techniques, and one or more computer readable media including instructions for performing one or more aspects of the disclosed techniques, as well as a method for performing one or more aspects of the disclosed techniques.

At least one technical advantage of the disclosed techniques relative to the prior art is that, with the disclosed techniques, different thread groups executing within a thread array can be configured with different allocations of resources and can independently increase or decrease the allocation of resources during execution. As a result, resources can be more efficiently allocated to thread groups relative to prior approaches. Further, because a producer thread array can release resources to a consumer thread array before the producer thread array completes execution, the execution of the producer thread array and the consumer thread array can overlap, resulting in further efficiencies. These advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computer system configured to implement one or more aspects of the various embodiments;

FIG. 2 is a block diagram of a parallel processing unit (PPU) included in the accelerator processing subsystem of FIG. 1, according to various embodiments;

FIG. 3 is a block diagram of a general processing cluster (GPC) included in the parallel processing unit (PPU) of FIG. 2, according to various embodiments;

FIG. 4 illustrates how a CTA executing on the PPU of FIG. 2 can be reconfigured, according to various embodiments;

FIG. 5 illustrates three CTAs executing consecutively on the PPU of FIG. 2, according to various embodiments;

FIG. 6 illustrates a reconfigurable CTA executing on the PPU of FIG. 2, according to various embodiments;

FIG. 7 is a state diagram illustrating how warps acquire and allocate resources on the PPU of FIG. 2, according to various embodiments;

FIG. 8 illustrates how warps allocate and deallocate registers during execution, according to various embodiments;

FIGS. 9A-9B illustrate data structures for managing registers for a warp executing in a CTA, according to various embodiments;

FIG. 10 illustrates a CTA free register pool for managing registers for a CTA free register pool, according to various embodiments;

FIGS. 11A-11B illustrate a shared memory linked list for managing shared memory for a warp executing in a CTA, according to various embodiments; and

FIG. 12 is a flow diagram of method steps for utilizing resources on an accelerator, such as the PPU of FIG. 2, according to various embodiments, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

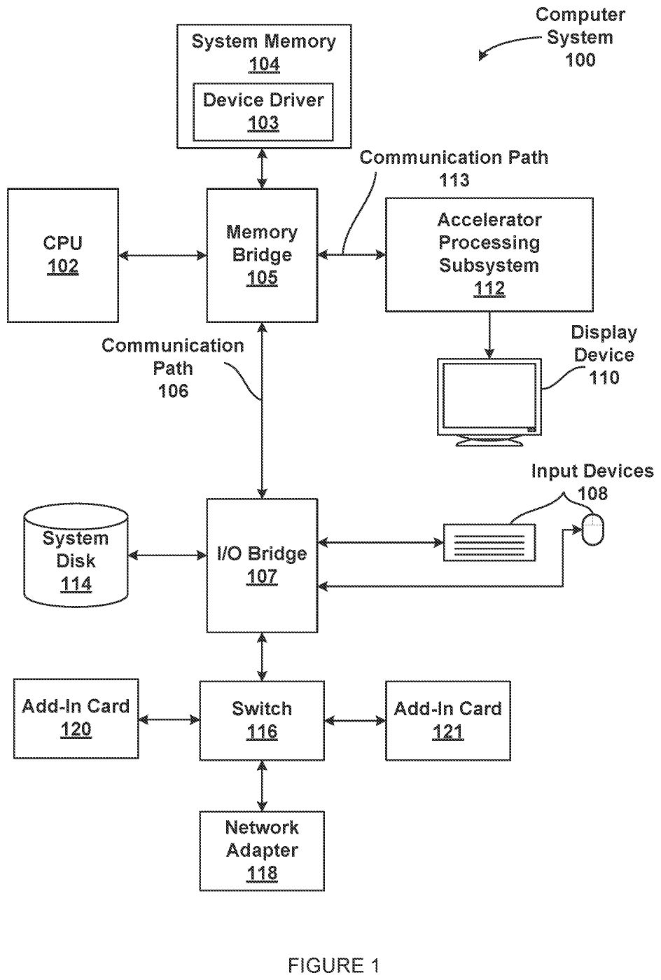

FIG. 1 is a block diagram of a computer system 100 configured to implement one or more aspects of the various embodiments. As shown, computer system 100 includes, without limitation, a central processing unit (CPU) 102 and a system memory 104 coupled to an accelerator processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and accelerator processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

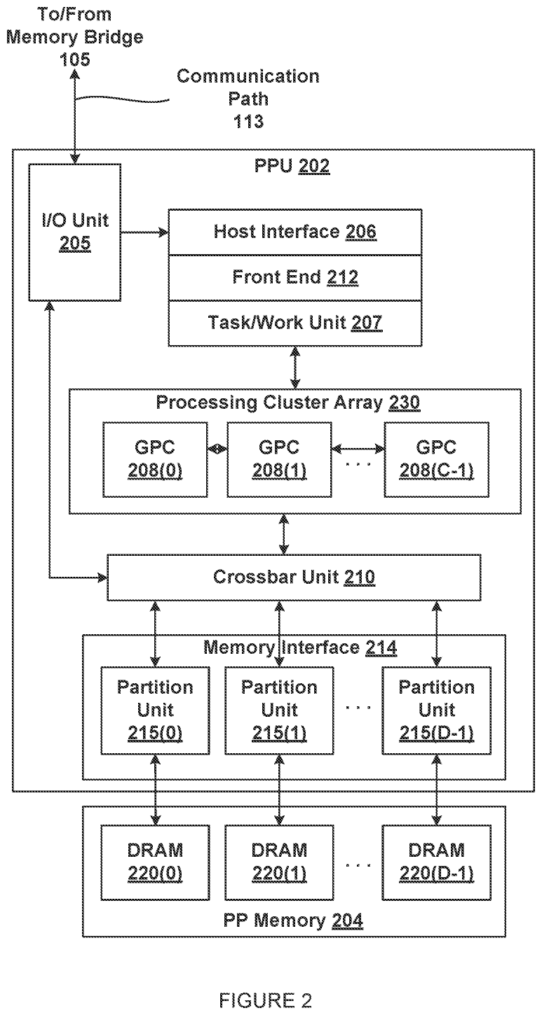

In some embodiments, accelerator processing subsystem 112 comprises a graphics subsystem that delivers pixels to a display device 110 that may be any conventional cathode ray tube, liquid crystal display, light-emitting diode display, or the like. In such embodiments, the accelerator processing subsystem 112 incorporates circuitry optimized for graphics and video processing, including, for example, video output circuitry. As described in greater detail below in FIG. 2, such circuitry may be incorporated across one or more accelerators included within accelerator processing subsystem 112. An accelerator includes any processing unit that can execute instructions such as a central processing unit (CPU), a parallel processing unit (PPU) of FIGS. 2-4, a graphics processing unit (GPU), an intelligence processing unit (IPU), neural processing unit (NAU), tensor processing unit (TPU), neural network processor (NNP), a data processing unit (DPU), a vision processing unit (VPU), an application specific integrated circuit (ASIC), a field-programmable gate array (FPGA), and/or the like. In other embodiments, the accelerator processing subsystem 112 incorporates circuitry optimized for general purpose and/or compute processing. Again, such circuitry may be incorporated across one or more accelerators included within accelerator processing subsystem 112 that are configured to perform such general purpose and/or compute operations. In yet other embodiments, the one or more accelerators included within accelerator processing subsystem 112 may be configured to perform graphics processing, general purpose processing, and compute processing operations. System memory 104 includes at least one device driver 103 configured to manage the processing operations of the one or more accelerators within accelerator processing subsystem 112.

In various embodiments, accelerator processing subsystem 112 may be integrated with one or more other the other elements of FIG. 1 to form a single system. For example, accelerator processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of accelerator processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, accelerator processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the accelerator processing subsystem 112 of FIG. 1, according to various embodiments. Although FIG. 2 depicts one PPU 202, as indicated above, accelerator processing subsystem 112 may include any number of PPUs 202. Further, the PPU 202 of FIG. 2 is one example of an accelerator included in accelerator processing subsystem 112 of FIG. 1. Alternative accelerators include, without limitation, CPUs, GPUs, IPUs, NPUs, TPUs, NNPs, DPUs, VPUs, ASICs, FPGAs, and/or the like. The techniques disclosed in FIGS. 2-4 with respect to PPU 202 apply equally to any type of accelerator(s) included within accelerator processing subsystem 112, in any combination. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computer system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computer system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computer system 100 may be varied. In some embodiments, accelerator processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C 1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D 1. Each partition unit 215 is coupled to one or more dynamic random access memories (DRAMs) 220 residing within PP memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPC 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity, and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within accelerator processing subsystem 112, or another accelerator processing subsystem 112 within computer system 100.

As noted above, any number of PPUs 202 may be included in an accelerator processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

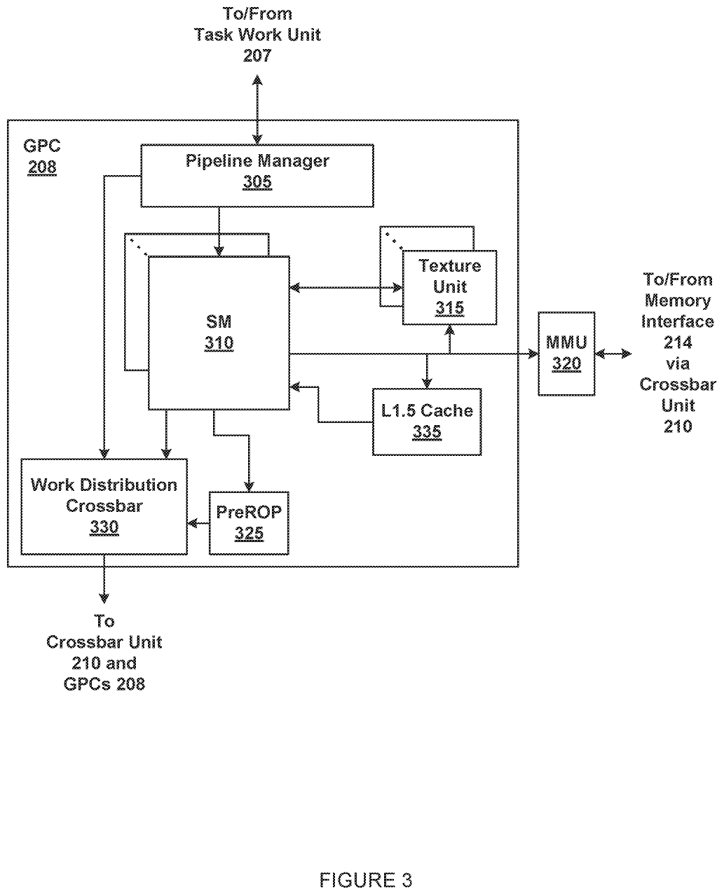

FIG. 3 is a block diagram of a general processing cluster (GPC) 208 included in the parallel processing unit (PPU) 202 of FIG. 2, according to various embodiments. In operation, GPC 208 may be configured to execute a large number of threads in parallel to perform graphics, general processing and/or compute operations. As used herein, a thread refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

Operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In one embodiment, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (e.g., AND, OR, XOR), bit-shifting, and computation of various algebraic functions (e.g., planar interpolation and trigonometric, exponential, and logarithmic functions, etc.). Advantageously, the same functional execution unit can be configured to perform different operations.

In operation, each SM 310 is configured to process one or more thread groups. As used herein, a thread group or warp refers to a group of threads concurrently executing the same program on different input data, with one thread of the group being assigned to a different execution unit within an SM 310. A thread group may include fewer threads than the number of execution units within the SM 310, in which case some of the execution may be idle during cycles when that thread group is being processed. A thread group may also include more threads than the number of execution units within the SM 310, in which case processing may occur over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a cooperative thread array (CTA) or thread array. The size of a particular CTA is equal to m*k, where k is the number of concurrently executing threads in a thread group, which is typically an integer multiple of the number of execution units within the SM 310, and m is the number of thread groups simultaneously active within the SM 310. In various embodiments, a software application written in the compute unified device architecture (CUDA) programming language describes the behavior and operation of threads executing on GPC 208, including any of the above-described behaviors and operations. A given processing task may be specified in a CUDA program such that the SM 310 may be configured to perform and/or manage general-purpose compute operations.

Although not shown in FIG. 3, each SM 310 contains a level one (L1) cache or uses space in a corresponding L1 cache outside of the SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, the SMs 310 may beneficially share common instructions and data cached in L1.5 cache 335.

Each GPC 208 may have an associated memory management unit (MMU) 320 that is configured to map virtual addresses into physical addresses. In various embodiments, MMU 320 may reside either within GPC 208 or within the memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In graphics and compute applications, GPC 208 may be configured such that each SM 310 is coupled to a texture unit 315 for performing texture mapping operations, such as determining texture sample positions, reading texture data, and filtering texture data.

In operation, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the core architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs. In view of the foregoing, persons of ordinary skill in the art will appreciate that the architecture described in FIGS. 1-3 in no way limits the scope of the various embodiments of the present disclosure.

Please note, as used herein, references to shared memory may include any one or more technically feasible memories, including, without limitation, a local memory shared by one or more SMs 310, or a memory accessible via the memory interface 214, such as a cache memory, parallel processing memory 204, or system memory 104. Please also note, as used herein, references to cache memory may include any one or more technically feasible memories, including, without limitation, an L1 cache, an L1.5 cache, and the L2 caches.

### Efficient Utilization of Resources on an Accelerator

Various embodiments include techniques for utilizing resources on a processor or other accelerator. With the disclosed techniques, different warps executing in the same CTA or CGA are dynamically configurable to be allocated different numbers of registers, as controlled by compiler instructions in the application program. Portions of shared memory are per CTA resources such that, during a reconfiguration operation, shared memory can be deallocated from an existing CTA and allocated to a new CTA in order to all the new CTA to launch. The disclosed techniques allow the application program to set up heterogenous warps in the CTA or CGA. The disclosed techniques allow the application program to increase the number of available registers for warps in the same CTA, such as warps executing mathematical functions. Similarly, the disclosed techniques allow the application program to decrease the number of available registers for certain other warps, such as warps in the same CTA that are executing data transfer functions. With the disclosed techniques, these two types of different warps, that is, warps executing mathematical functions and warps executing data transfer functions, can exist within the same CTA.

In addition, with the disclosed techniques, warps can proactively release registers and/or shared memory prior to exiting the CTA. As a result, the system can launch other CTAs from the same grid and/or other CTAs from independent grids earlier than with prior approaches. For example, a producer kernel that generates data for a consumer kernel can release registers and/or shared memory prior to completion of the producer kernel. The producer kernel can release the registers and/or shared memory at a point when the producer kernel has a reduced need for these resources. The consumer kernel can acquire the registers and/or shared memory from the producer kernel after the producer kernel releases the resources and prior to completion of the producer kernel. As a result, the system executes with increased efficiency because the consumer kernel can launch and begin execution concurrently with the producer kernel completing execution, thereby reducing dependent kernel-to-kernel latency.

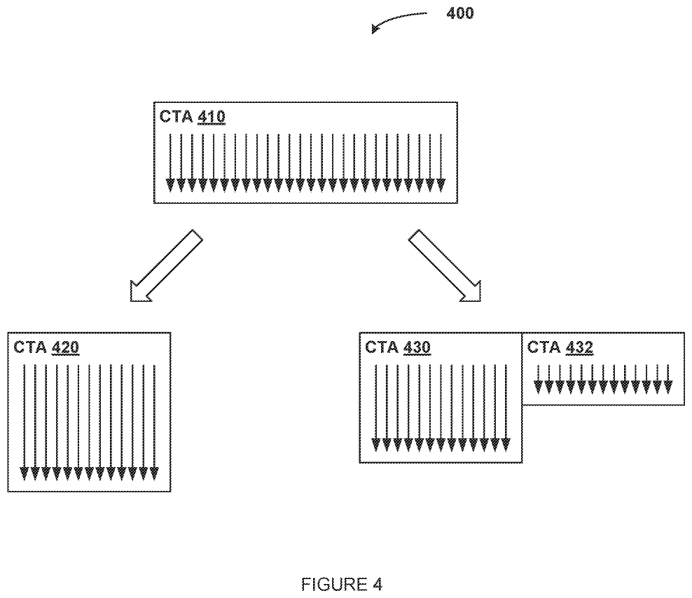

FIG. 4 illustrates how a CTA 400 executing on the PPU 202 of FIG. 2 can be reconfigured, according to various embodiments. As shown, the CTA 400 is initially configured as a CTA 410 with a specified number of threads and a specified amount of resources, such as registers and/or shared memory. For example, the CTA 410 could be configured as 512 threads with 32 registers per thread. At a certain point during execution of the CTA 410, the CTA 410 can be reconfigured into one or more other CTAs with a different number of threads and/or registers per thread.

In one example, the CTA 410 could determine that functions that are about to be executed would benefit from executing on a CTAs 420 having more registers per thread. Therefore, the CTA 410 could be reconfigured as a CTA 420 with fewer threads and more registers per thread, such as 256 threads with 64 registers per threads. The overall register footprint has not changed because the original CTA 410 is allocated 512 threads×32 registers per thread=16,384 registers, while the reconfigured CTA 420 is allocated 256 threads×64 registers per thread=16,384 registers.

In another example, the CTA 410 could determine that functions that are about to be executed would benefit from executing on different CTAs 430 and 432 with different numbers of registers per thread. Therefore, the CTA 410 could be reconfigured as two CTAs 430 and 432. The first CTA 430 could be configured 256 threads with 48 registers per thread, for a total of 12,288 registers. The second CTA 430 could be configured 256 threads with 16 registers per thread, for a total of 4,096 registers. Again, the overall register footprint has not changed because the original CTA 410 is allocated 16,384 registers while the combination of CTAs 430 and 432 is allocated 12,288 registers+4,096 registers=16,384 registers.

As shown, the CTA 400 can be initially configured as a CTA 410 with a specified number of threads and a specified amount of resources and can be configured as a single CTA 420 or as multiple CTAs 430 and 432 with any number of threads and resources, so long as the overall resource footprint of the CTA 400 does not change. The CTA 400 is reconfigurable as the CTA 400 executes, without having to terminate the CTA 400 and launch one or more new CTAs with different configurations. As a result, reconfiguring the CTA 400 during execution reduces or eliminates the time needed with prior approaches to terminate a CTA having one configuration and launching one or more CTAs with different configurations.

In some embodiments, a kernel can reconfigure a CTA 400 based on the result of a dynamic condition check that executes during the runtime of the kernel and generates a result. When the CTA 400 launches, the kernel initially and conservatively selects a resource footprint that is sufficient for the majority of the kernel execution time. The resource footprint defines the amount of resources, such as registers and shared memory, to allocate to the CTA 400. The CTA 400 acquires resources based on the selected resource footprint. During execution, the kernel performs a dynamic condition check that generates a result in order to determine which branch from among a set of two or more branches to execute. Each branch can consume a different amount of resources and, therefore, can execute with a different resource footprint. Further, the branch taken by the CTA 400 depends on runtime conditions that the compiler cannot determine a priori. In some examples, a first branch consumes a large resource footprint that is similar or identical with the initial resource footprint. A second branch consumes a medium resource footprint, and a third branch consumes a small resource footprint. If the result generated by the dynamic condition check indicates that the CTA 400 executes the first branch, then the resource allocation remains the same. If the result generated by the dynamic condition check indicates that the CTA 400 executes the second branch or the third branch, then the resource footprint of the CTA 400 is reconfigured during runtime to consume fewer resources. The freed resources are returned to the free pool and are available for reuse by other CTAs from same grid and/or CTAs from other independent grids.

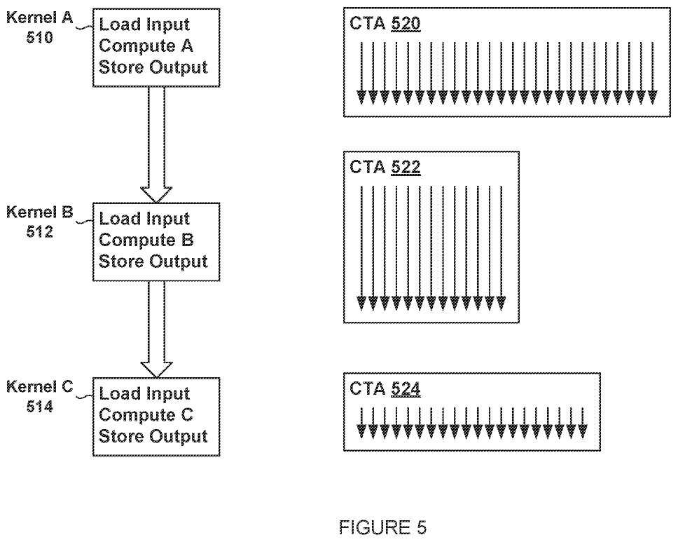

FIG. 5 illustrates three CTAs 520, 522, and 524 executing consecutively on the PPU 202 of FIG. 2, according to various embodiments. As shown, kernel A 510 launches a first CTA 520 with a specified configuration, such as 512 threads×32 registers per thread=16,384 registers. The configuration for CTA 520 may be well suited for functions that benefit from executing on a large number of threads with a moderate number of registers per thread. Kernel A 510 loads input data from memory, such as shared memory. Kernel A 510 then executes various functions, illustrated as Compute A in FIG. 5. Kernel A 510 stores the output resulting from executing the functions in shared memory. Kernel A 510 then terminates and CTA 520 releases all threads, registers, and other resources.

Kernel B 512 launches a second CTA 522 with a specified configuration, such as 256 threads×64 registers per thread=16,384 registers. The configuration for CTA 522 may be well suited for functions that benefit from executing on a small number of threads with a large number of registers per thread. Kernel B 512 loads input data from memory, such as shared memory. This input data may be the output data stored by kernel A 510. Kernel B 512 then executes various functions, illustrated as Compute B in FIG. 5. Kernel B 512 stores the output resulting from executing the functions in shared memory. Kernel B 512 then terminates and CTA 522 releases all threads, registers, and other resources.

Kernel C 514 launches a third CTA 524 with a specified configuration, such as 384 threads×16 registers per thread=6,144 registers. The configuration for CTA 524 may be well suited for functions that benefit from executing on a moderate number of threads with a small number of registers per thread. Kernel C 514 loads input data from memory, such as shared memory. This input data may be the output data stored by kernel B 512. Kernel C 514 then executes various functions, illustrated as Compute C in FIG. 5. Kernel C 514 stores the output resulting from executing the functions in shared memory. Kernel C 514 then terminates and CTA 524 releases all threads, registers, and other resources.

Executing kernels 510, 512, and 514 sequentially efficiently utilizes registers and other resources. However, the time overhead needed to store the output of one CTA and terminate that CTA plus the time to launch the subsequent CTA and load the input data for the subsequent CTA can be significant. Kernels 510, 512, and 514 can be merged into a single reconfigurable CTA to reduce or eliminate this time overhead.

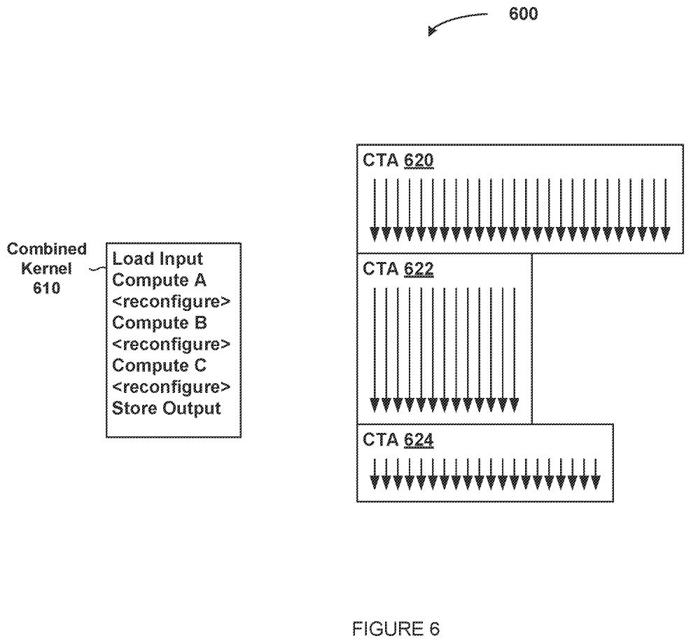

FIG. 6 illustrates a reconfigurable CTA 600 executing on the PPU 202 of FIG. 2, according to various embodiments. As shown, a combined kernel 610 launches a first CTA 620 with a specified configuration, such as 512 threads×32 registers per thread=16,384 registers. The configuration for CTA 620 may be well suited for functions that benefit from executing on a large number of threads with a moderate number of registers per thread. Kernel 610 loads input data from memory, such as shared memory. Kernel 610 then executes various functions, illustrated as Compute A in FIG. 6. Kernel 610 determines that subsequent functions, illustrated as Compute B in FIG. 6, benefit from executing on a small number of threads with a large number of registers per thread.

Kernel 610 executes a command to change the configuration of CTA 600, such as 256 threads×64 registers per thread=16,384 registers. During reconfiguration, the 512−256=256 excess threads exit and/or are suspended. Excess threads that are no longer needed to execute kernel 610 exit. Other kernels can then allocate the exited threads to perform work via other CTAs. Threads that are not needed to execute CTA 622 but are needed to execute subsequent CTAs for kernel 610 are suspended. Suspended threads are not available to other kernels for allocation. Kernel 610 may exit some threads and suspend others. For example, kernel 610 may exit 128 of the 256 excess threads, so that the 128 excess threads may be allocated by other kernels. Kernel 610 may suspend 128 of the 256 excess threads, so that the 128 suspended threads are available for executing subsequent CTAs, such as CTA 624. Both the exiting threads and the suspended threads release their resources, such as registers, shared memory, and/or the like, to the free pool. The remaining 256 threads acquire 32 additional registers per thread from the free pool for a total of 64 registers per thread. The additional registers may be the registers released by the exited and suspended threads from CTA 620. Additionally or alternatively, the additional threads may be any other registers available from the free pool.

After reconfiguration, CTA 622 has a new configuration, such as 256 threads×64 registers per thread=16,384 registers. Kernel 610 executes functions, illustrated as Compute B, on CTA 622. Kernel 610 determines that subsequent functions, illustrated as Compute C in FIG. 6, benefit from executing on moderate number of threads with a small number of registers per thread.

Kernel 610 executes a command to change the configuration of CTA 600, such as 384 threads×16 registers per thread=6,144 registers. During reconfiguration, the 128 suspended threads are activated for a total of 256+128=384 threads. If no suspended threads are available, kernel 610 acquires additional threads from the PPU 202. The 256 threads of CTA 622 each release 64−16=48 registers to the free pool. The 128 suspended threads each acquire 16 registers from the free pool. The registers may be the registers released by the 256 threads from CTA 622. Additionally or alternatively, the additional threads may be any other registers available from the free pool.

After reconfiguration, CTA 624 has a new configuration, such as 384 threads×16 registers per thread=6,144 registers. Kernel 610 executes functions, illustrated as Compute C, on CTA 624. Kernel 610 determines that no other functions remain for execution. Kernel 610 stores the output resulting from executing the functions in shared memory. Kernel 610 then terminates and CTA 624 releases all remaining threads, registers, shared memory, and/or other resources.

Executing kernel 610 with reconfigurable CTAs efficiently utilizes registers and other resources. Further, executing kernel 610 with reconfigurable CTAs reduces or eliminates the time overhead of executing sequential CTAs, as shown in FIG. 5.

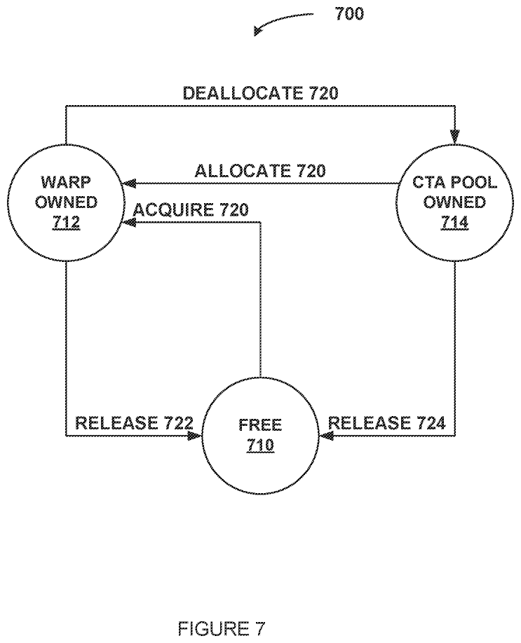

FIG. 7 is a state diagram 700 illustrating how warps acquire and allocate resources on the PPU 202 of FIG. 2, according to various embodiments. As shown, resources, such as registers, transition among three states: free 710, warp owned 712, and CTA pool owned 714. The CTA pool owned 714 state is also referred to herein as a thread array owned state.

Initially, resources are in the free 710 state. A resource is free when the resource is not owned by a warp (i.e., in the warp owned 712 state) or by the CTA pool (i.e., in the CTA pool owned 714 state). When a warp launches, the warp acquires resources via an acquire 720 operation. The acquired resources transition from the free 710 state to the warp owned 712 state. When the warp completes, the warp frees the resources via a release 722 operation. Further, the warp may programmatically release resources via a release 722 operation. In either case, the resources transition from the warp owned 712 state to the free 710 state. When the CTA completes, the CTA frees any resources in the CTA pool via a release 724 operation. The resources transition from the CTA pool owned 714 state to the free 710 state.

Resources in the warp owned 712 state are usable by threads executing in the respective warp. Over time, a warp may determine that fewer resources are needed than are currently owned by the warp. In such cases, the warp deallocates the excess resources via a deallocate operation 726. The excess resources transition from the warp owned 712 state to the CTA pool owned 714 state. If the warp subsequently attempts to access a resource that has been deallocated, an out-of-range error is triggered.

Over time, a warp may determine that more resources are needed than are currently owned by the warp. In such cases, the warp allocates the resources via an allocate operation 728. The resources transition from the CTA pool owned 714 state to the warp owned 712 state. If the requested resources are not available in the CTA pool, the warp stalls pending availability of the requested resources.

The CTA pool maintains a set of available resources for all warps executing in the CTA. Resources in the CTA pool are unavailable for use by a warp until the warp allocates the resources via an allocate operation 728. When the CTA completes, the CTA frees any resources in the CTA pool via a release 724 operation. The resources transition from the CTA pool owned 714 state to the free 710 state.

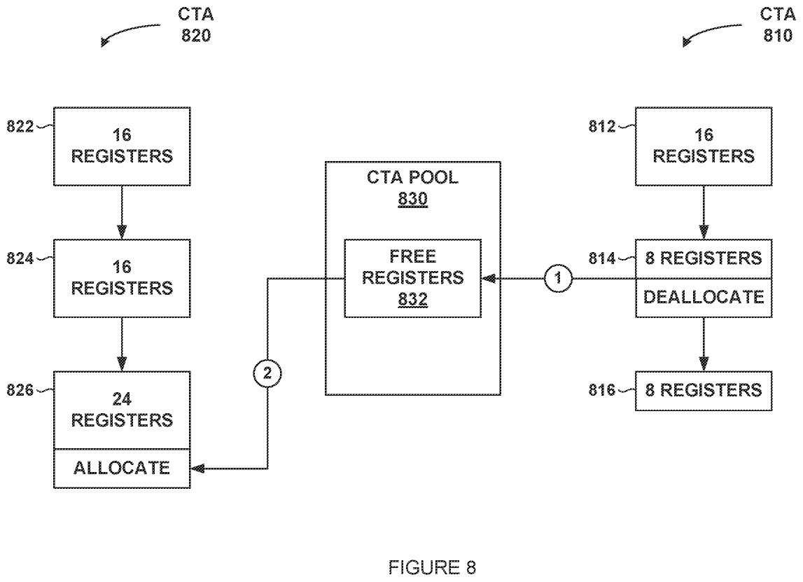

FIG. 8 illustrates how warps allocate and deallocate registers during execution, according to various embodiments. As shown, two warps 810 and 820 are executing in a CTA. Warp 810 launches with an initial 16 registers per thread at stage 812. Over time, warp 810 determines that only 8 registers per thread are needed for subsequent functions. Warp 810 deallocates 8 registers per thread at stage 814. After deallocation, warp 810 now has the remaining 8 registers per thread at stage 816. The deallocated registers are placed in the free registers 832 within the CTA pool 830.

Warp 820 launches with an initial 16 registers per thread at stage 822. Over time, warp 820 determines that 24 registers per thread are needed for subsequent functions. Warp 820 requests 8 registers per thread at stage 824 and waits for the registers to be available in the free registers 832 of the CTA pool. When the registers are available, warp 820 allocates the registers at stage 826. After allocation, warp 820 now has 24 registers per thread at stage 826. The allocated registers are removed from the free registers 832 within the CTA pool 830.

Because of the CTA pool 830, warp 810 and warp 820 do not need to execute concurrently. In one example, warp 810 executes and deallocates registers at stage 814 prior to warp 820 executing and requesting registers at stage 824. In such cases, registers deallocated by warp 810 remain until requested by warp 820 or another warp in the CTA. When warp 820 subsequently requests additional registers at stage 824, and a sufficient number of free registers 832 are in the CTA pool 830, then warp 820 immediately allocates the registers from the CTA pool 830.

In another example, warp 820 executes and requests registers at stage 824 prior to warp 810 executing and deallocating registers at stage 814. In such cases, warp 820 stalls at stage 824 pending deallocation of registers by warp 810 or another warp in the CTA. Registers deallocated by warp 810 remain until requested by warp 820 or another warp in the CTA. When warp 810 subsequently deallocates registers at stage 814, then warp 820 unstalls and allocates the registers from the CTA pool 830.

In general, data in registers allocated by warp 810 is indeterminate. Because warps in a CTA may execute in any order, warp 820 does not know whether warp 810 is the source of the registers allocated at stage 826, or whether another warp is the source of the registers. In some embodiments, source warps tag deallocated registers with an identifier (ID) when deallocating registers to the CTA pool 830. The ID may identify the source warp and/or the destination warp. Additionally or alternatively, the ID may be an arbitrary identifier known to both the source warp and the destination warp. When the destination warp requests additional registers, the destination warp includes the ID in the request. The destination warp waits until the registers with the correct ID are available in the free registers 832 of the CTA pool 830. When the registers with the correct ID are available, the destination warp allocates those registers. As a result, the data stored in the registers by the source warp prior to deallocation remains in the registers when the destination warp allocates the registers. In this manner, registers tagged with such IDs may be employed to pass data between source warps and destination warps.

Further, in some embodiments, consecutive dependent CTAs may overlap execution. For example, two CTAs may execute in three phases, prologue, main processing, and epilogue. The prologue phase includes initial processing data acquisition for the main processing. The main processing phase executes various functions, such as mathematical functions. After the main loop phase executes the functions and generates output data, the epilogue phase stores the output data in shared memory. In general, the epilogue phase requires fewer registers and/or shared memory than the main processing phase. Therefore, a first CTA can release registers and/or shared memory after the main loop phase and before the epilogue phase. A second CTA that depends on the first CTA can launch and begin executing the prologue phase, including acquiring resources released by the first CTA. When the second CTA reaches a point of dependency on data generated by the first CTA, the second CTA stalls until the dependency resolves. After the dependency resolves, and the data from the first CTA is available, the second CTA resumes execution. In this manner, execution of dependent CTAs may overlap, thereby increasing performance.

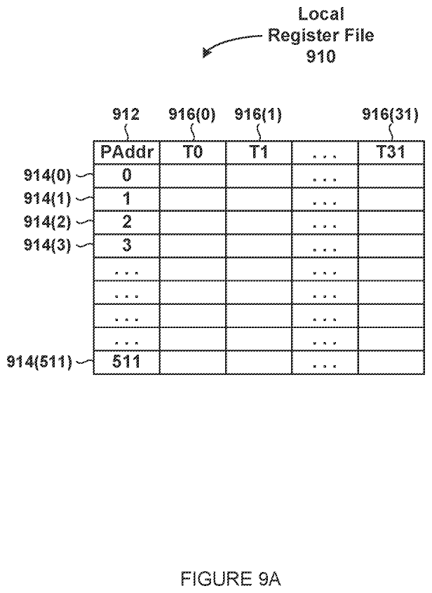

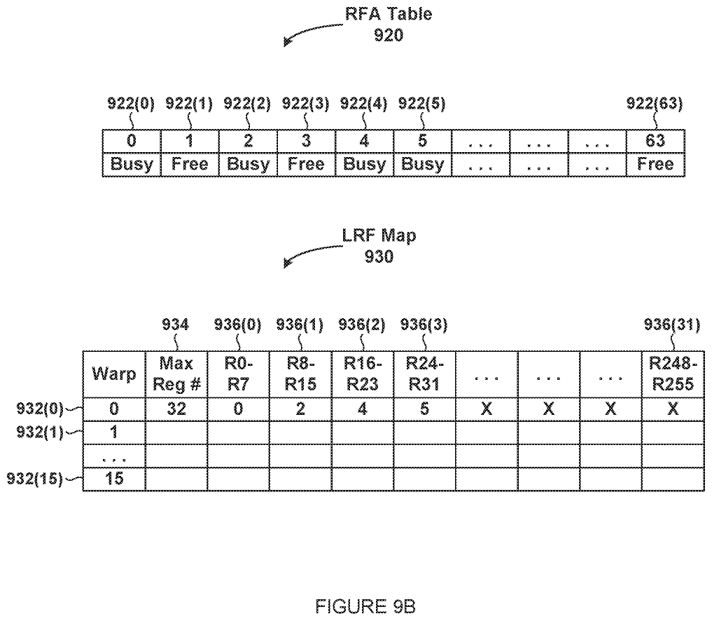

FIGS. 9A-9B illustrate data structures for managing registers for a warp executing in a CTA, according to various embodiments. As shown, the data structures include, without limitation, a local register file 910, a register file status table 920, and a local register file map 930. These data structures are replicated for each warp executing in the CTA. The local register file 910 includes 512 registers 914(0), 914(1), 914(2), 914(3), . . . 914(511). Each register 914 has a physical address (paddr) 912 correspondingly numbered from 0 to 511. Each register includes a four-byte (32-bit) storage location for each of 32 threads 916(0), 916(1), . . . 916(31).

The status of the registers 914 in the local register file 910 is tracked via a status parameter in a register file status table 920. The registers 914 in the local register file 910 are allocated in 64 physical register blocks 922 of 8 registers per physical register block 922. These 64 physical register blocks 922 are numbered from 0 to 63. Physical register block 922(0) corresponds to registers 914(0)-914(7), physical register block 922(1) corresponds to registers 914(8)-914(15), physical register block 922(2) corresponds to registers 914(16)-914(23), and so on. Physical register blocks 922 that are currently acquired or allocated by the warp are tagged with a status parameter indicating a busy status. Physical register blocks 922 that are not currently acquired or allocated by the warp are tagged with a free status. As shown, physical register blocks 922(0), 922(2), 922(4), and 922(5) are tagged with a status parameter indicating a busy status. Physical register blocks 922(1), 922(3), and 922(63) are tagged with a status parameter indicating a free status.

Warps access registers 914 via a logical address rather than a physical address. Each warp addresses the registers 914 assigned to the warp starting at logical address 0 and proceeding consecutively, even if the physical addresses of the registers 914 assigned to the warp do not start at physical address 0 and/or are not contiguous in the physical address 912 space of the local register file 910. The logical address to physical address mapping is tracked via a local register file map 930, wherein the logical addresses are addressable by the threads in the warp. The local register file map 930 includes one entry for each warp 932(0), 932(1), . . . 932(15). Each warp may acquire and/or allocate up to 32 logical register blocks 936(0), 936(1), . . . 936(31) of 8 registers each, for a total of 256 registers, subject to the availability of registers 914 in the local register file 910. The maximum register number (max reg #) 934 for warp 932(0) is 32, indicating that warp 932(0) has acquired and/or allocated 32 registers per thread. The 32 registers are logically address from 0 to 31. Registers R0-R7 are in logical register block 936(0), registers R8-R15 are in logical register block 936(1), registers R16-R23 are in logical register block 936(2), and registers R24-R31 are in logical register block 936(3). Logical register block 936(0) for warp 932(0) is mapped to physical register block 922(0), corresponding to registers 914 with physical addresses 912 from 0 to 7. Logical register block 936(1) for warp 932(0) is mapped to physical register block 922(2), corresponding to registers 914 with physical addresses 912 from 16 to 23. Logical register block 936(2) for warp 932(0) is mapped to physical register block 922(4), corresponding to registers 914 with physical addresses 912 from 32 to 39. Logical register block 936(3) for warp 932(0) is mapped to physical register block 922(5), corresponding to registers 914 with physical addresses 912 from 40 to 47.

To allocate or deallocate registers, a resource allocator located in the PPU 202 updates the register file status table 920 and local register file map 930 to reflect the allocation or deallocation. For example, the resource allocator can deallocate 16 of the 32 registers 914 for warp 932(0) by invalidating the physical register block numbers for logical register block 936(2) and logical register block 936(3) in the local register file map 930. The resource allocator changes the status parameter of physical register block 922(4) and physical register block 922(5) from busy to free. The resource allocator updates the maximum registers number 934 for warp 932(0) from 32 to 16. Subsequently, warp 932(0) can allocate 8 additional registers 914 by storing the physical register block number of the allocated of physical register block 922 in logical register block 936(2). The resource allocator changes the status parameter of the physical register block 922 from free to busy. The resource allocator updates the maximum registers number 934 for warp 932(0) from 16 to 24.

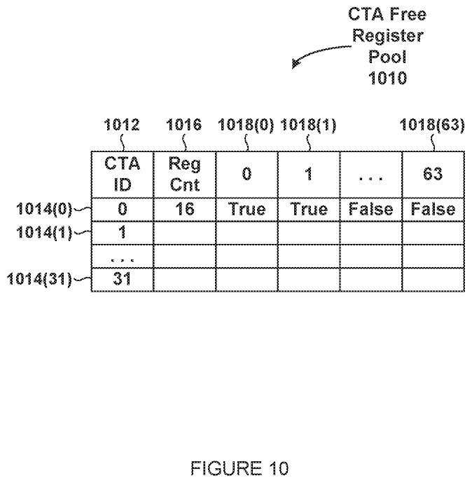

FIG. 10 illustrates a CTA free register pool 1010 for managing registers for a CTA free register pool 1010, according to various embodiments. As shown, the CTA free register pool 1010 include one CTA entry 1014(0), 1014(1), . . . 1014(31) for each of 32 CTAs. Each CTA entry 1014(0), 1014(1), . . . 1014(31) corresponds to a CTA identifier (ID) 1012. The CTA free register pool 1010 tracks the number of free register blocks 1018(0), 1018(1), . . . 1018(31) on a CTA-by-CTA basis. The number of free register blocks for each CTA is tracked via a register count (reg cnt) parameter 1016. Each CTA entry 1014(0) can have up to 32 free register blocks 1018(0), 1018(1), . . . 1018(31) in the CTA free register pool 1010. Initially, the free register blocks 1018(0), 1018(1), . . . 1018(31) are set to false for all CTA entry 1014(0), 1014(1), . . . 1014(31), indicating that the CTA free register pool 1010 has no free register blocks.

In some examples, the warp described in conjunction with FIGS. 9A-9B is executing in the CTA corresponding to CTA entry 1014(0) with a CTA identifier 1012 of 0. When the warp deallocates 16 registers, as a set of two blocks of 8 registers, the resource allocator updates CTA entry 1014(0) by setting free register blocks 1018(0), 1018(1) to true, indicating that the CTA now has two free register blocks 1018(0), 1018(1). Subsequently, when the warp allocates 8 registers, the resource allocator updates CTA entry 1014(0) by setting free register block 1018(1) to false, indicating that the CTA now has one free register block 1018(0).

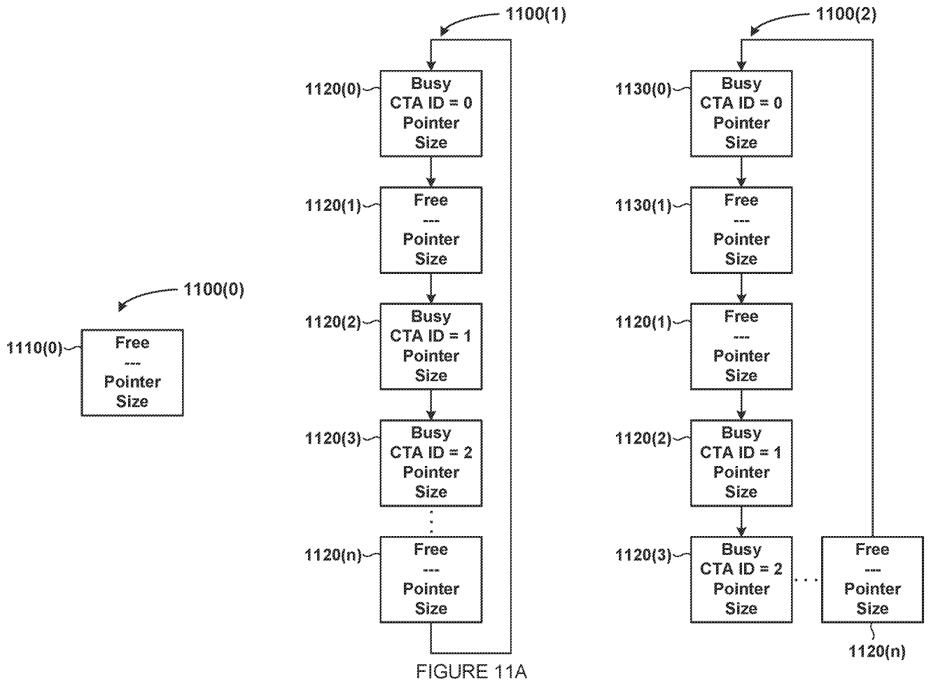

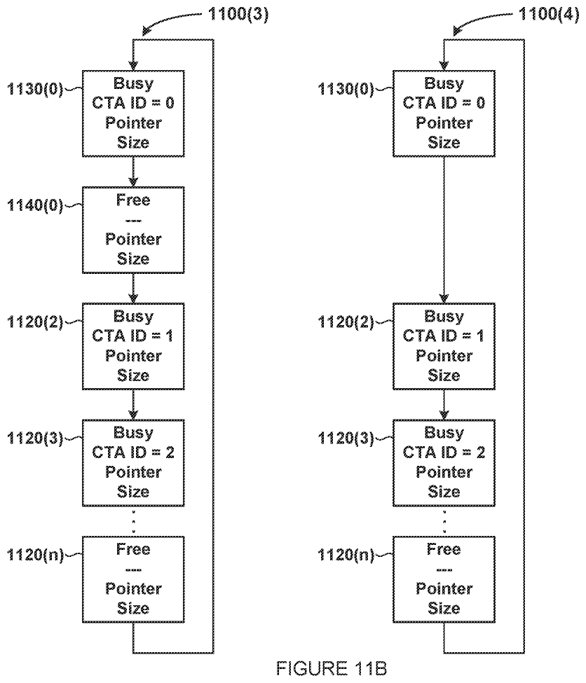

FIGS. 11A-11B illustrate a shared memory linked list 1100 for managing shared memory for a warp executing in a CTA, according to various embodiments. As shown, the shared memory linked list 1100 includes various entries, referred to herein as nodes, that identify shared memory blocks as busy or free. A status parameter of a shared memory block is set to busy if the shared memory block is acquired by a CTA. The state of a busy shared memory block is CTA owned. If a shared memory block is busy, then the corresponding node includes the CTA ID, a pointer to the beginning of the shared memory block, and a size parameter indicating the size of the shared memory block.

A status parameter of a shared memory block is set to if the shared memory block is not acquired by any CTA or has been released by a CTA that previously acquired the shared memory block. The state of a free shared memory block is free. If a shared memory block is free, then the corresponding node includes a pointer to the beginning of the shared memory block and a size parameter indicating the size of the shared memory block. The CTA ID of a free shared memory block is invalid because no CTA currently owns the shared memory block.

Initially, the entire shared memory is free, and can be represented by a shared memory linked list 1100(0) with a single node 1110(0). The node 1110(0) identifies the shared memory block as free. The pointer in the node 1110(0) points to the first address in shared memory and the size parameter in the node 1110(0) indicates the size of the entire shared memory. Over time, CTAs acquire portions of shared memory and release portions of shared memory. In some examples, the current shared memory linked list 1100(1) can include a set of nodes 1120(0), 1120(1), 1120(2), 1120(3), . . . 1120(n). Node 1120(0) is a busy node with CTA ID=0. Node 1120(1) is a free node. Nodes 1120(2) and 1120(3) are busy nodes with CTA ID=1 and CTA ID=2, respectively. Other intermediate nodes (not shown) may be any combination of busy nodes and/or free nodes. Each node 1120 in the shared memory linked list 1100(1) points to the next consecutive node, and the last node 1120(n) in the shared memory linked list 1100(1) points to the first node 1120(0). In this manner, the nodes form a circular linked list. The number of nodes may increase and/or decrease over time as the number of busy and free shared memory blocks increases and/or decreases, respectively.

Nodes in the shared memory linked list 1100(1) may be split and/or merged as CTAs acquire and release shared memory blocks. In some examples, the CTA with CTA ID=0 may release a portion of shared memory block owned by the CTA. In so doing, the resource allocator splits node 1120(0) into two nodes. The resource allocator replaces node 1120(0) with a first node 1130(0) and adds a second node 1130(1). The first node 1130(0) represents the retained and busy portion of the shared memory block. The resource allocator sets the pointer and size parameter in the first node 1130(0) based on the location and size of the retained portion of the shared memory block. The second node 1130(1) represents the released and free portion of the shared memory block. The resource allocator sets the pointer and size parameter in the second node 1130(1) based on the location and size of the free portion of the shared memory block. The new nodes 1130(0) and 1130(1) are shown in the shared memory linked list 1100(2).

Subsequently, when the resource allocator is not processing allocation and deallocation requests for CTAs, the resource allocator may merge the consecutive free nodes 1130(1) and 1120(1) into a single free node 1140(0). The resource allocator sets the pointer and size parameter in the free node 1140(0) based on the location and total size of the two free shared memory blocks. The merged node 1140(0) is shown in the shared memory linked list 1100(3).

Subsequently, the CTA with CTA ID=0 may acquire additional shared memory. In so doing, the CTA may acquire part or all of the free memory represented by node 1140(0). If the CTA acquires part of the free memory represented by node 1140(0), then the resource allocator updates the size parameter in node 1130(0) to reflect the sum of the previous size of the busy shared memory block and the acquired portion of the free memory block. The resource manager updates the pointer and size parameter in node 1140(0) to reflect the new starting location and reduced size of the free memory block.

If the CTA acquires all of the free memory represented by node 1140(0), then the resource allocator updates the size parameter in node 1130(0) to reflect the sum of the previous size of the busy shared memory block and the size of the free memory block. The resource manager eliminates node 1140(0) as shown in the shared memory linked list 1100(4).

It will be appreciated that the system shown herein is illustrative and that variations and modifications are possible. As described herein, registers are acquired, allocated, deallocated, and released in blocks of 8 registers. However, registers may be acquired, allocated, deallocated, and released in blocks of any arbitrary size. Further, the registers may be of any register size, number of registers, and across any number of threads in a warp. Similarly, shared memory may be acquired, allocated, deallocated, and released in blocks of any arbitrary size. As described, the techniques may be applied to warps executing in a CTA. However, the techniques may also be applied to warps and CTAs executing in a CGA, within the scope of the present disclosure. Further, the early resource release techniques can apply to any one or more critical resources in the system, including registers, shared memory, and/or the like.

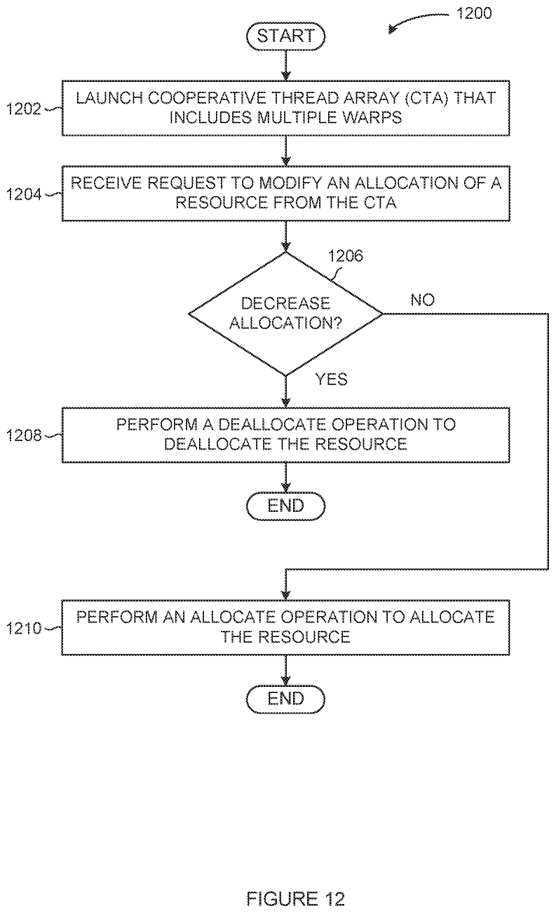

FIG. 12 is a flow diagram of method steps for utilizing resources on an accelerator, such as the PPU 202 of FIG. 2, according to various embodiments. Additionally or alternatively, the method steps may be performed by one or more alternative accelerators including, without limitation, CPUs, GPUs, IPUs, NPUs, TPUs, NNPs, DPUs, VPUs, ASICs, FPGAs, and/or the like, in any combination. Although the method steps are described in conjunction with the systems of FIGS. 1-11B, persons of ordinary skill in the art will understand that any system configured to perform the method steps, in any order, is within the scope of the present disclosure.

As shown, a method 1200 begins at step 1202, where a resource allocator included in the accelerator launches a cooperative thread array (CTA) that includes multiple warps. The resource allocator assigns resources to the CTA, such as threads, registers, shared memory, and/or the like. Each of the warps in the CTA acquire a portion of threads, registers, shared memory, and/or other resources based on the launch parameters that specify the number of threads in each warp, the number of registers per warp, the amount of shared memory per warp, and/or the like.

At step 1204, the resource allocator receives a request to modify a resource allocation from the CTA. The CTA transmits a request to the resource allocator to increase a register allocation, decrease a register allocation, increase a shared memory allocation, decrease a shared memory allocation, and/or the like. During execution, the CTA may execute multiple functions concurrently, consecutively, and/or conditionally. In some examples, a first function may be well suited for a CTA that executes on a large number of threads with a moderate number of registers per thread. A second function may be well suited for a CTA that executes on a small number of threads with a large number of registers per thread. A third function may be well suited for a CTA that executes on a moderate number of threads with a small number of registers per thread, and so on. Accordingly, the resource requirements of the CTA change during execution.

At step 1206, the resource allocator determines whether the request is to decrease an allocation or to increase an allocation. If the resource allocator determines that the request is to decrease an allocation, then the method proceeds to step 1208, where the resource allocator performs a deallocate operation to deallocate the resource to a free pool.

To deallocate registers, the resource allocator updates a register file status table and a local register file map to reflect the deallocation. For example, the resource allocator can deallocate a portion of the registers for a warp by invalidating physical register block numbers for the logical register blocks in the local register file map that correspond to the deallocated registers. The resource allocator warp changes the status parameter of corresponding physical register blocks from busy to free. The resource allocator updates the maximum registers number for the warp to reflect the reduced number of registers owned by the warp. The deallocated registers can now be allocated to the same warp and/or other to warps in the CTA.

To deallocate or release a portion of the shared memory owned by the CTA, the resource allocator modifies one or more nodes in a shared memory linked list. The busy nodes in the linked list include pointer and size values that specify the location and size of busy shared memory blocks that are owned by various CTAs. The free nodes in the linked list include pointer and size values that specify the location and size of free shared memory blocks that are not owned by any CTAs.

The resource allocator replaces a node representing the busy shared memory block owned by the CTA with a first node and a second node. The first node represents the portion of the shared memory block retained by the CTA and, therefore, is busy. The resource allocator sets the pointer and size in the first node based on the location and size of the retained portion of the shared memory block. The second node represents the released and free portion of the shared memory block. The resource allocator sets the pointer and size in the second node based on the location and size of the free portion of the shared memory block.

The method 1200 then terminates. Alternatively, the method 1200 proceeds to step 1204 to process additional requests to modify resource allocations.

Returning to step 1206, if the resource allocator determines that the request is to increase an allocation, then the method proceeds to step 1210, where the resource allocator performs an allocate operation to allocate the resource from a free pool.

To allocate registers, the resource allocator updates the register file status table and the local register file map to reflect the allocation. For example, the resource allocator can allocate additional registers for a warp by storing the physical register block number of the allocated of physical register block in one or more logical register blocks. The resource allocator changes the status parameter of the physical register block from free to busy. The resource allocator updates the maximum registers number for the warp to reflect the increased number of registers owned by the warp. The newly allocated registers can no longer be allocated to the other to warps in the CTA until deallocated by the warp.

To allocate or acquire an additional portion of the shared memory, the resource allocator again modifies one or more nodes in the shared memory linked list. The CTA may acquire part or all of the free memory represented by a free node that is consecutive to the busy node representing the CTA. If the CTA acquires part of the free memory represented by the free node, then the resource allocator updates the size in busy node to reflect the sum of the previous size of the busy shared memory block and the acquired portion of the free memory block. The resource manager updates the pointer and size in the free node to reflect the new starting location and reduced size of the free memory block. If the CTA acquires all of the free memory represented by the free node, then the resource allocator updates the size in the busy node to reflect the sum of the previous size of the busy shared memory block and the size of the free memory block. The resource manager eliminates the free node.

The method 1200 then terminates. Alternatively, the method 1200 proceeds to step 1204 to process additional requests to modify resource allocations.

In sum, various embodiments include techniques for utilizing resources on a processor or other accelerator. With the disclosed techniques, different warps executing in the same CTA or CGA are dynamically configurable to be allocated different numbers of registers, as controlled by compiler instructions in the application program. Further, different warps executing in the same CTA or CGA are dynamically configurable to be allocated different amounts of shared memory. The disclosed techniques allow the application program to set up heterogenous warps in the CTA or CGA. The disclosed techniques allow the application program to increase the number of available registers for certain warps, such as warps executing mathematical functions. Similarly, the disclosed techniques allow the application program to decrease the number of available registers for certain other warps, such as warps executing data transfer functions.

In addition, with the disclosed techniques, warps can proactively release registers and/or shared memory prior to exiting the CTA. As a result, the system can launch other CTAs from the same grid and/or other CTAs from independent grids earlier than with prior approaches. For example, a producer kernel that generates data for a consumer kernel can release registers and/or shared memory prior to completion of the producer kernel. The producer kernel can release the registers and/or shared memory at a point when the producer kernel has a reduced need for these resources. The consumer kernel can acquire the registers and/or shared memory from the producer kernel after the producer kernel releases the resources and prior to completion of the producer kernel. As a result, the system executes with increased efficiency because the consumer kernel can launch and begin execution concurrently with the producer kernel completing execution, thereby reducing dependent kernel-to-kernel latency.

At least one technical advantage of the disclosed techniques relative to the prior art is that, with the disclosed techniques, different thread groups executing within a thread array can be configured with different allocations of resources and can independently increase or decrease the allocation of resources during execution. As a result, resources can be more efficiently allocated to thread groups relative to prior approaches. Further, because a producer thread array can release resources to a consumer thread array prior to completing execution of the producer thread array, the execution of the producer thread array and the consumer thread array can overlap, resulting in further efficiencies. These advantages represent one or more technological improvements over prior art approaches.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for launching compute tasks on a processing unit, the method comprising:
launching a first group of threads, wherein one or more resources included in a free pool are acquired by the first group of threads; and
during execution of the first group of threads, changing an allocation of the one or more resources acquired by the first group of threads.

2. The computer-implemented method of claim 1, further comprising launching a second group of threads, wherein one or more resources included in the free pool are acquired by the second group of threads.

3. The computer-implemented method of claim 2, wherein the one or more resources acquired by the first group of threads are different in size from the one or more resources acquired by the second group of threads.

4. The computer-implemented method of claim 2, wherein the first group of threads and a second group of threads are included in a first thread array.

5. The computer-implemented method of claim 2, wherein the first group of threads executes a first function, and the second group of threads executes a second function that is different from the first function.

6. The computer-implemented method of claim 2, wherein the first group of threads executes a first program that includes mathematical functions, and the second group of threads executes a second program that includes data transfer functions.

7. The computer-implemented method of claim 1, further comprising transitioning a state of the one or more resources acquired by the first group of threads from a free state to a warp owned state.

8. The computer-implemented method of claim 1, further comprising, during execution of the first group of threads:
deallocating a first resource included in the one or more resources acquired by the first group of threads; and
transitioning a state of the first resource from a warp owned state to a thread array owned state.

9. The computer-implemented method of claim 8, further comprising, during execution of the first group of threads:
allocating the first resource to a second group of threads; and
transitioning a state of the first resource from the thread array owned state to the warp owned state.

10. The computer-implemented method of claim 9, wherein the first group of threads and the second group of threads are included in a first thread array.

11. The computer-implemented method of claim 9, wherein the first group of threads passes a value to the second group of threads via the first resource.

12. The computer-implemented method of claim 1, further comprising:
determining that the first group of threads has completed execution; and
transitioning a state of the one or more resources acquired by the first group of threads from a warp owned state to a free state.

13. The computer-implemented method of claim 1, further comprising, during execution of the first group of threads:
changing a number of threads included in the first group of threads; and
changing an allocation of the one or more resources acquired by the first group of threads.

14. The computer-implemented method of claim 1, wherein the free pool includes at least one of a set of registers or a portion of a shared memory.

15. The computer-implemented method of claim 1, further comprising, during execution of the first group of threads:
deallocating a first resource included in the one or more resources acquired by the first group of threads from the first group of threads; and
launching a second group of threads, wherein the first resource is allocated to the second group of threads.

16. The computer-implemented method of claim 1, further comprising:
executing a dynamic condition check to generate a result;
determining that the result indicates that the first group of threads executes a first branch included in a plurality of branches;
determining that resources for executing the first branch are different from the one or more resources acquired by the first group of threads; and
changing an allocation of the one or more resources acquired by the first group of threads based on the resources for executing the first branch.

17. A system, comprising:
a processor that executes one or more threads; and
a resource allocator that is coupled to a resource set, wherein the resource allocator:
launches a first group of threads, wherein one or more resources included in a free pool are acquired by the first group of threads; and
during execution of the first group of threads, changing an allocation of the one or more resources acquired by the first group of threads.

18. The system of claim 17, wherein the resource allocator further launches a second group of threads, wherein one or more resources included in the free pool are acquired by the second group of threads.

19. The system of claim 18, wherein the one or more resources acquired by the first group of threads are different in size from the one or more resources acquired by the second group of threads.

20. The system of claim 17, wherein, during execution of the first group of threads, the resource allocator further:
deallocates a first resource included in the one or more resources acquired by the first group of threads from the first group of threads; and
transitions a state of the first resource from a warp owned state to a thread array owned state.
